(19) United States
(12) Patent Application Publication
(10) Pub. No.: US 2019/0009113 A1
(43) Pub. Date: Jan. 10, 2019

(54) RESCUE SYSTEM FROM HIGH RISE APARTMENTS WITH AUTOMATIC HYDRO MECHANIC CONTROL AND WITHOUT ELECTRICITY

(71) Applicant: Sajad Esmaili, Shiraz (IR)

(72) Inventor: Sajad Esmaili, Shiraz (IR)

(21) Appl. No.: 15/522,764

(22) PCT Filed: Oct. 25, 2015
(86) PCT No.: PCT/IB2015/058221

§ 371 Date: Jun. 21, 2017

(30) Foreign Application Priority Data
Oct. 30, 2014 (IR) 13935014000300839

(51) Int. Cl. A62B 1/12; F03C 1/00; F03C 1/16; F04B 1/00; F04B 1/34; F03C 1/02

(52) U.S. Cl. CPC A62B 1/12; F03C 1/004; F03C 1/02; F04B 1/005; F04B 1/34; F03C 1/16

(57) ABSTRACT

There is a pressing problem in the design of high-rise apartments and towers during the occurrence of the events like explosion, fire, earthquake since the inhabitants are not able to get out of the building and they get trapped in the dangerous situations.

Currently all around the world, there are some systems but they have not met the urgent requirements and we annually witness lots of death tolls caused by fire and explosion.

In order to remove the above-mentioned deficiencies, a new system has been designed which creates the possibility of transferring people from heights to the downside of the apartment in emergency conditions without requiring any energy.

The device works by converting the potential gravitational power of weight into kinetic and heat energy. This operation is done by controlling and converting the function of a variable and invariable hydraulic pump or hydro motor which is connected to two grooves spool and the pump outlet is controlled by a control valve and centrifugal governor. The control operation causes the spool steel wire to be slowly opened. Consequently the person descends. This system works like a hydrodynamic damper.

### FIELD OF THE INVENTION

The technical background of this invention is related to the mechanic, dynamic and fluid hydraulic. The present invention is a new device used for rescuing the people inside the apartment in dangerous conditions.

### BACKGROUND OF THE INVENTION

There is a pressing problem in the design of high-rise apartments and towers during the occurrence of the events like explosion, fire, earthquake since the inhabitants are not able to get out of the building and they get trapped in the dangerous situations.

Currently all around the world, there are some systems but they have not met the urgent requirements and we annually witness lots of death tolls caused by fire and explosion.

### 1—Emergency Evacuation Device for High-Rise Apartments:

The device consists of a chain of rope which is dragged down via the weight connected to it and then the inhabitants connect themselves to pairs Pulley by a safety belt and the rope is inserted between the two pulleys. The brake of the two pulleys is frictional shoes inside the brakes drum. The friction shoe acts as a brake.

Using this Device is Easy but it has the Following Limitations:

Not controlling the weight change for the people with different weights, the inadequate friction between the rope and the two pulleys, and the need for two pulleys for each person are included among the restrictions of device. Moreover, when the rope is stuck the whole route is blocked. If the rope gets stuck, it does not reach the earth, and the user will collapse.

2—the Emergency Device for Evacuating People from the Building

This device contains a basket connected to a winch which is installed on the roof of the building and is controlled electrically.

Using this device is safe. However, this device does not work without the operator, or without electric power. It definitely needs the direct vertical direction inside the building wall and if the rails are deformed in fire flames, the people get caught at the heights in the middle of the fire.

3—Landing Device for Creating the Possibility of Rescuing from High Rise Buildings, Tower or Similar Ones

The device includes a safety belt connected to a rope expanding spool and when the person wears the belt and connects the rope head to a point, he/she can descend. The brake of the device is a bowl frictional brake inside the spool. The device descends with the person. The device cannot adjust its speed according to different weights. Since it does not have a distance with the wall, friction is created between the user and the body of the device or the rope gets torn and as a result the descent risk increases.

### SUMMARY OF THE INVENTION

In order to remove the above-mentioned deficiencies, a new system has been designed which creates the possibility of transferring people from heights to the downside of the apartment in emergency conditions without requiring any energy.

The device works by converting the potential gravitational power of weight into kinetic and heat energy. This operation is done by controlling and converting the function of a variable and invariable hydraulic pump or hydro motor which is connected to two grooves spool and the pump outlet is controlled by a control valve and centrifugal governor. The control operation causes the spool steel wire to be slowly opened. Consequently the person descends. This system works like a hydrodynamic damper.

This invention is installed on the special metal panel, on the building wall, next to the window, or on the high area of each construction. The segments include a two grooves spool whose steel wires are opened and twisted around the spool in an opposite direction. People can come down by freeing the wires twisted around the spool.

The brake of the spool is a hydraulic pump or hydro motor the rotation speed of which is adjusted by the fluid outlet valve of regulator. The regulation of outlet valve is completed by the Centrifugal governor which depends on the spool's rotation and flow control valve compensated.

While needed, a person presses a mechanic bottom available on the container wall and collapsible folding stair, wears the special harness and connects the anti-shock clasp of special harness to the device. Then, the person comes to the window edge by the collapsible folding stairs of windows and the only thing that needs to be done is to throw yourself out of the window so that you can come down very easily with the help of the system designed in the spool.

As the first person goes down, the spool opens from the first groove at the same time and the second groove gets filled with wire reversely (by wire on the freewheeling spool) and the next person can use it for descending. As the second person comes down, the first spool goes up so that the third person can use it for coming down at the same time.

In case the user is sick or old and there is a need for slower or faster decent, the device can be adjusted manually by a flow control valve which has the ability to control the speed.

A system without a need to electricity which is connected to the spools and causes the person at any weight to move downside with a 1 m/s speed, designed in two figures which are totally similar regarding their functions.

The device has an interface for connecting to electric engine and it acts as a traction or power winch in special applications or according to the user's request.

Regarding the usage conditions, this device is designed and manufactures in three models but with the same applications and advantages suitable for the usage environment.

### BRIEF DESCRIPTION OF THE DRAWINGS

1. A general view of the device

2. Safety belt and interface clasp

3. Hydro-mechanic design of automatic control

4. Axial hydro mechanic design of automatic control

5. Hydro mechanic design of electric control

### DESCRIPTION OF THE DRAWINGS

In the first figure a general view of the device is illustrated which is constituted from protecting body 1, device body 2, Wire Steel Spool 3, User clasp 4, freewheeling spool to reserve steel rope 5, and Device lid 6.

The second figure shows the parts of safety belt and anti-shock clasp interface. This part has different segments. Anti-shock clasp 7, connecting clasp to device 8, light alarm 8, Siren 9, shock absorber of anti-shock clasp 10.

The safety belt is made of wide strand of silk and is fastened around the waist by a clasp 11. The safety belt rope 12 and strap and safety belt clasp 13 are the other parts of this figure.

The third figure depicts the system designed for moving a person down with the highest level of safety. This system is designed in such a way that any person with any weight connects to it and comes down at the same speed. The device is automatically ready to be reused after each descent.

Crankshaft 14 is used to change the rotational movement into the linear movement which is required for the piston pump. The linear movement of plungers (special piston) pumps the hydraulic oil in the circuit.

The other segments include: Connecting rod 15, connecting rod pin 16 for Connecting rod interface and piston plunger connection, piston plunger 17 which acts like the hydraulic jacks, sealing packing 18 which is used for sealing and preventing oil spill from the free space between plunger and cylinder, cylinder 19, high pressure one sided outlet valve 20, the output current path 21 which is responsible for guiding the high pressure flow of hydraulic cylinder toward the flow regulator controllers, regulating output flow aperture 22 which is related to the flow regulating spool, the control valve sensitive to the hydraulic fluid speed and control valve of hydraulic impact 23, pressure reducing valve and flow rate regulation of fluid output 24, special flow control valve 25, fluid tank, filter and hydraulic radiator 26 to which all of the inputs and outputs are connected, the input path of hydraulic fluid into the cylinder 27 which is an interface pipe between the tank and cylinder and works as a feeding input of device pump, the one sided input pump 28, flow control spool 29 which is a piston with a regulating aperture of flow rate which is dependent on the device governor, returned spring of flow control spool 30, this spring brings the spool back to the first place after the spring goes up, Rockers spool flow control 31 and the Rockers transfers the governor reactions to the fluid control spool, connector bush 32, centrifugal governor 33, sprocket (gearbox and winch) 34, the handle of winch gearbox 35, cylinder body 36 made of aluminum casting for piston plunger cylinder body, thermal insulation 37 which is made of mineral wool and used for the protection of device against the fire flames, device coverage 38 for protection of device against the weather, two grooves spool 39, to transfer and lead steel wire, tensile steel rope 40 with a insulation and refractory coating with a length compatible with the height of the device from the ground and the ring connecting to the user at the end of the wire, freewheeling spool 41 special for maintaining the steel wire of the second groove of the spool for the decent of the second person.

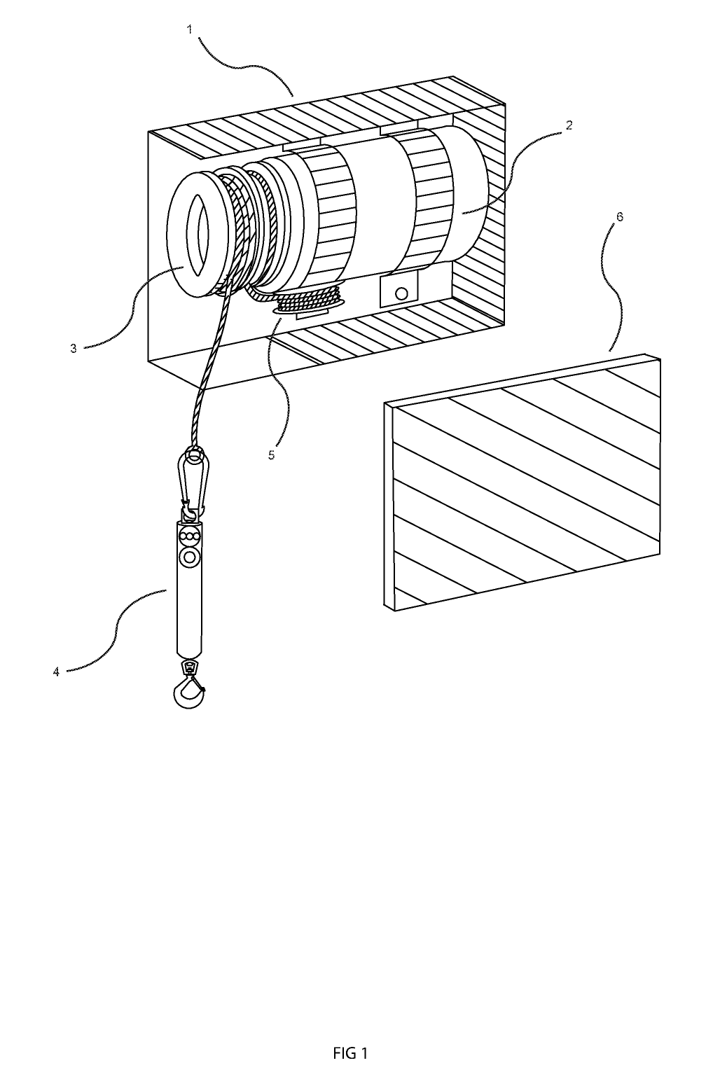

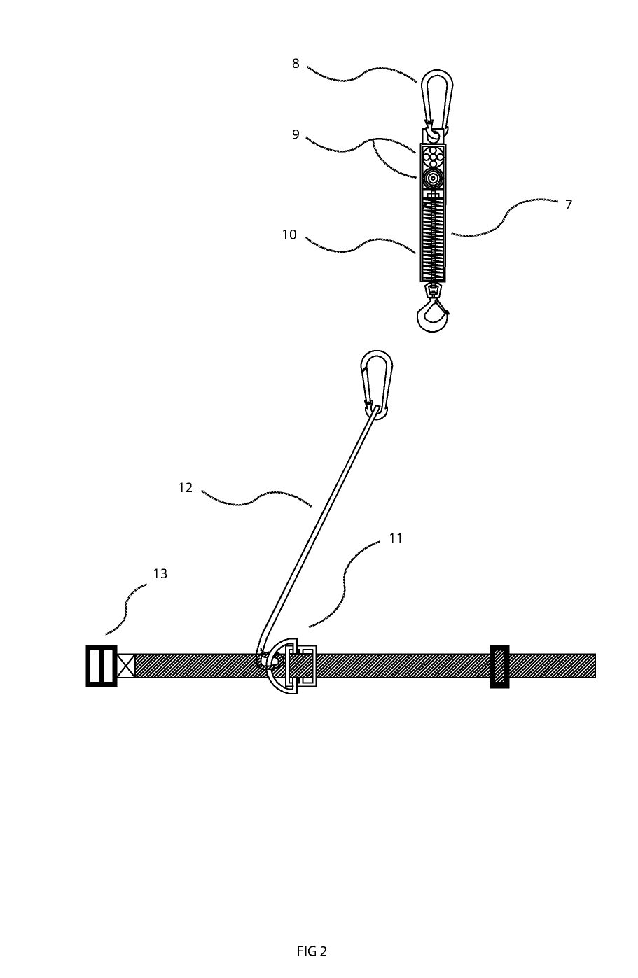

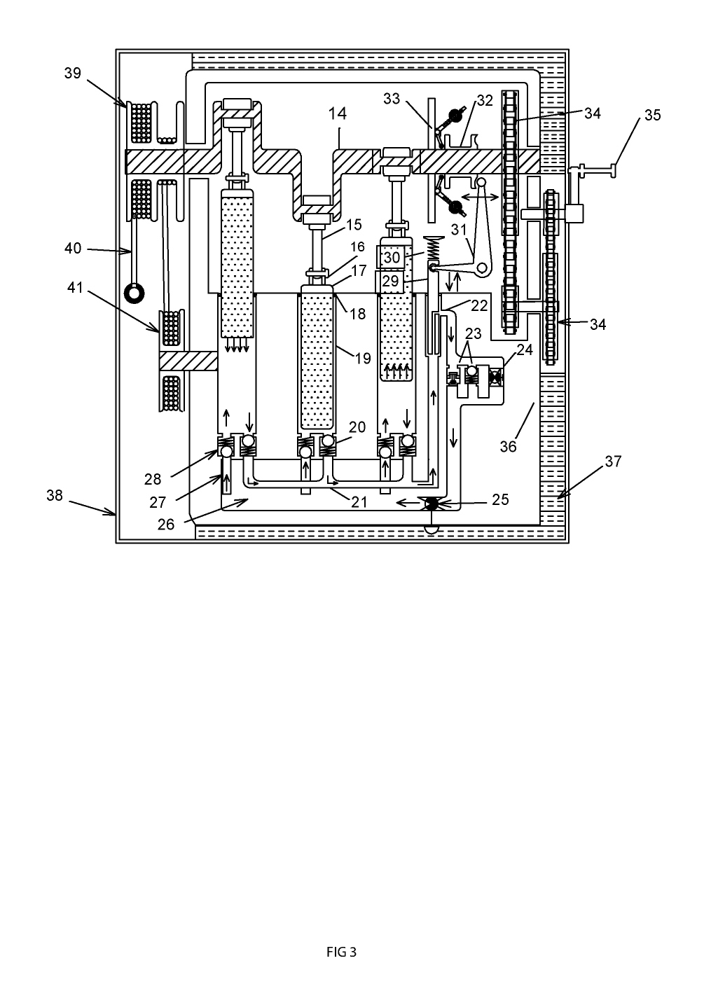

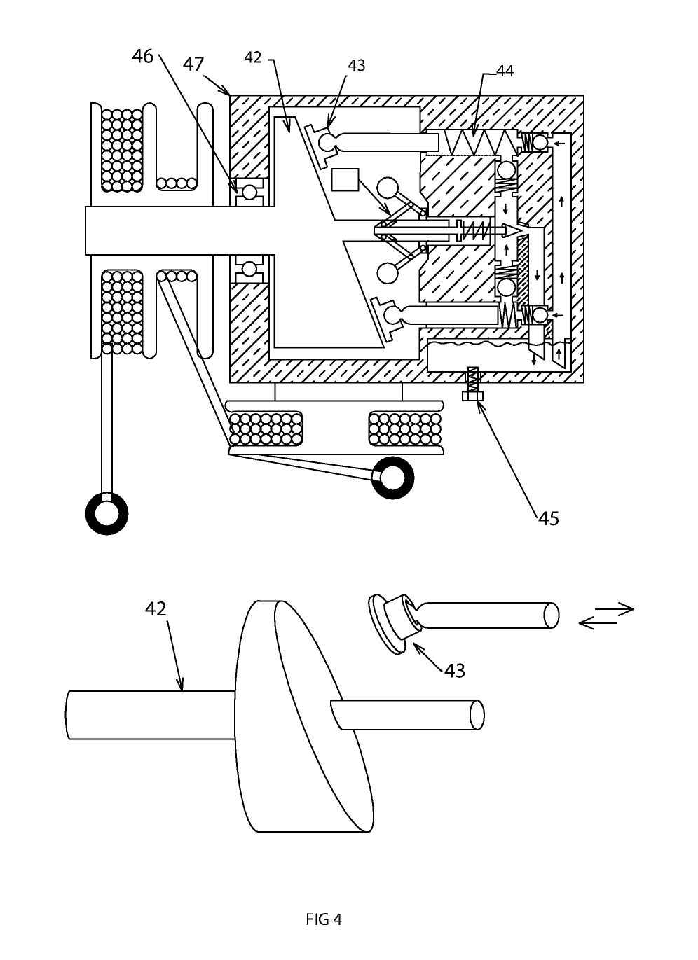

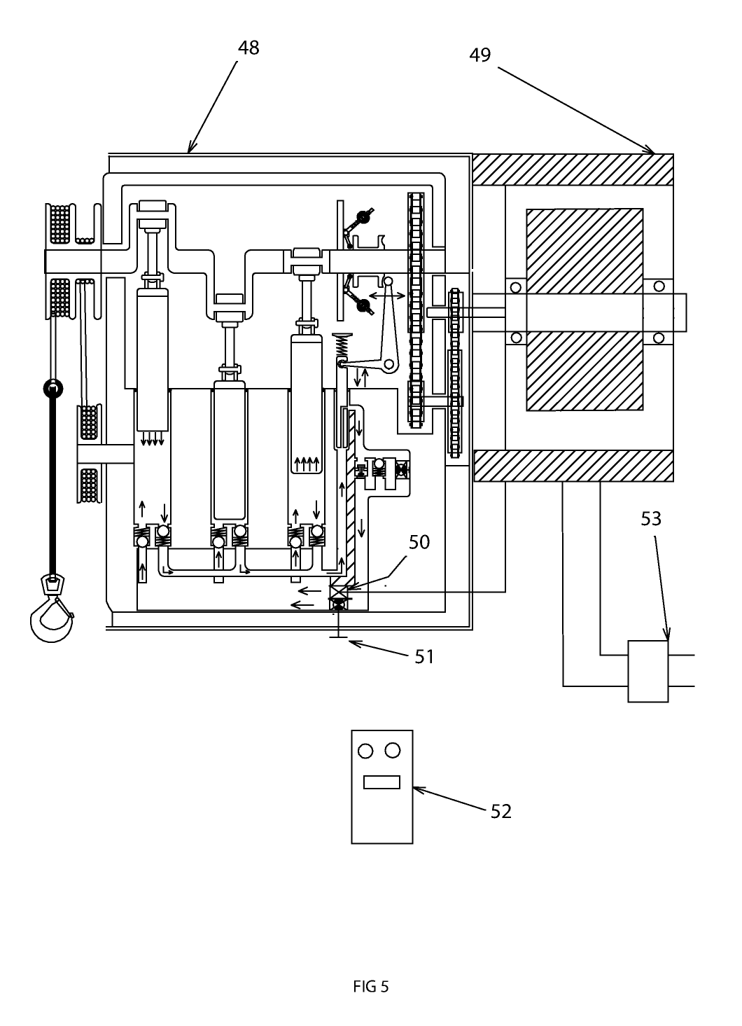

In FIG. 4, the fundamental of this system operation is similar to the invention number 1. The only difference is that the shape of the crankshaft has changed and the cylinder is like a cylindrical block. The shaft that has been used has an angled polished plate called swash plate. The angled crankshaft 42 is used to change the rotational movement into the linear one which is needed for piston pump. When the plungers mover in a linear way (special piston) the hydraulic oil will be pumped into the circuit.

Other segments include: Sliding Shoe of piston to slip on the swash plate, spring 44 returning piston, tank drain screw 45, bearing 46 of axis shaft, cylindrical block of cylinder 47 made of aluminum or casting steel

In figure number 5, the previous system is seen. The only difference is that an electric engine 49 is installed on the manual gearbox of the rear part of the device. It also has a feeding source 53. Since in this device the lifting is done by the electro motor, a normal close flow control valve 40 is installed and it gets opened during the lifting, landing or when the electro motor is opened.

In order to manually open the outlet path, a manual valve 51 will be used. There is also a remote control 52 to control the electric motor.

The advantage of this device is that it provides the possibility of lifting tools or people to the user. Even if no power is connected to the device, it works without electric power like the previous model. Moreover, this system has the same feature of controlling speed when carrying loads in different weights.

### The Operation of the Device:

The hydraulic fluid is pumped in the circuit when the plunger moves in a linear manner in the piston. A crankshaft is used to provide the linear movement. The flow control system controls the speed of the linear movement of plungers by regulating the extent of outlet flow rate of high pressure flow in the circuit which finally results in controlling the rotational movement of the crankshaft.

Hydraulic flow control system has two parts: 1. Variable control 2. Stable control. The variable control system consists of the slow limiting spool and independent two-way flow control valve. The flow limiting spool is an angular velocity-sensitive governor (centrifugal pendulum). When the angular velocity (rotation) increases, the pendulum crankshafts tend toward the outside part of the plate. The flow control moves upward via the rockers of interface spool. As the spool goes up, the sectional diameter of outlet decreases. As a result, the pressure in the circuit increases and the movement of piston slows down which causes the speed of the crankshaft to decrease, as well. As the speed of the crankshaft decreases, the spool returns to its first place by the installed spring and the opening of the path causes the flow to increase again. This action and reaction creates a balanced cycle and makes the angular speed stable in a certain area.

The two-way flow control valve acts separately from the pressure imposed on the circuit. The extent of flow passing from it is permanently stable. A pressure compensator is used in this valve which does not let the change in the input or output pressure have an impact on the flow passing from the valve and keeps the pressure discrepancy stable. This valve makes the piston plunger work with an adjusted and stable speed in different loads.

Stable control has three parts. The first one is globe valve; the extent of passing flow depends on the extent of circuit load pressure and causes a change in the extent of passing flow. The second one is pressure limiting valve which is used to control the pressure. This valve is closed at the primary manner. During the hydraulic stroke the stroke is neutralized. The third one is the flow limiting valve in the high speed and when the disk of valve fluid flow speed increases, this valve gets closed while normally it is opened. Therefore, the intensity of flow decreases and the linear speed of the plunder decreases and as a result the rotational speed of the crankshaft is caused.

The user at any weight is connected to the tensile wire and creates a variable torque caused by the weight since the angular speed of the crankshaft is controlled by the hydraulic circuit system. Spool has two grooves for the wires. The first groove is wire twirling and is used for landing while the second grove has a wire as long as the first groove but it is not wire twirling. The wire of second groove twirls around a freewheeling spool.

When the first user descends, the first groove string of the twisted wire is opened. At the same time, the other string of wire which is twisted around the freewheeling spool is twisted inside the empty side of second groove. It means when the first user descents and the groove of the wire connected to it is emptied; the second groove is automatically full of wire and is prepared to be used by the second user. When the second user lands, the second groove are emptied and the rope of first groove is twisted again and this procedure continues like a regular cycle.

This device has a gearbox system composed of some sprockets which gives more power with more rotations with the increase or decrease of the diameter of 4 gearwheels.

### DETAILED DESCRIPTION OF ADVANTAGES

1. It can be installed in any kind of building or construction and there is no need for changing the architecture of the building or the construction even in the old ones.
2. It works without electricity and there is no limitation for height and it can be used for any building with any height.
3. Using the device is continually and unlimited. It means the device is prepared after each time of usage.
4. It can be installed on any area like the walls, roofs, concrete and metal structures, ceilings, . . .
5. The installation does not need any external factor like the column or special bars
6. The descent speed of the device is stable and safe. It means people do not get damaged while coming down because of the downfall
7. It is not dependent on the building exit and the escape way is not blocked if the building is collapsed.
8. Applicability for the children, women, infants, and elderly is very easy (fasten the safety belts and throw yourself)
9. The size and volume of the device is very small and it does not hurt the beauty of the building
10. The possibility of using several devices simultaneously or one device for one building. Due to the stable speech, no interference is caused among them.
11. To run the device there is no need for the external regulation and the device is automatically calibrated at any weight or height and it maintains the stable maximum speed of 1.5 m/s.
12. This device can also be used as a special safety belt. For example, in case the device is installed in electrical towers or telecommunications and the technicians are electric shocked, then there is no need for the presence of rescue team to bring the person down and the fainted person is transferred down when he/she is freed from the electricity.
13. The ability to be installed on all of the towers and the elevated tanks of oil refinery, and power plans for quick escape from the endangered area.

### Explaining the Invention Application

After breaking the talc of inside panel and taking the safety belt or the other required tools inside the panel, fasten the anti-shock belt around you, then connect the head of clasp to the wire ring, after than come to the edge of the window and drop yourself down.

When the first person reaches down, the second person fastens another safety belt and connects the anti-shock clasp to the wire clasp of the second groove of the device and rescues himself like the first person.

Since the second person has freed himself from the first safety belt, with the descent of the second person, the first clasp and safety belt gets opened and the third person fastens the safety belt around him and comes down and the process continues like this.

1- Fabrication of rescue system from highly-elevated buildings using automatic hydrometrical control which is operator and energy free, consists of the following items:
a. Crankshaft (14)
b. Plunger (17)
c. Cylinder Blocks (19)
d. Outlet Check Valves (20)
e. Pressure Reducing Valve (23)
f. Brake Valve (24)
g. Pressure-compensated Flow Control Valve (25)
h. Hydraulic Reservoir (26)
i. Inlet Check Valves (28)
j. Flow Control Spool (29)
k. Variable Centrifugal governor with ability to change the speed of reaction (33)
l. Swipe Up Manual Gearbox (34)
m. Two-Groove Spool (39)
n. Fireproofing insulation (37)
o. Fireproof shield (38)
p. Siren-Equipped & Laser an optical warning-equipped anti-shock hook and Steel wire landing and anti-shock hook (40)
q. Freewheeling Spool (41)

2. Rescue system from highly-elevated apartment consists of a system exciter which is a standard hydraulic plunger pump (open loop) with three plungers (17) and three cylinders (19) that each cylinder has separate inlet check valve (28) and outlet check valve (20). All of which are enclosed in the common casing (38) that crankshaft (14) and parts are lubricated with oil.

3. According to claim 2: in every crankshaft (14) revolution, the suction, compression and discharge cycles occur completely.

4. According to claim 1: the system using automatic control is equipped with standard open loop hydraulic plunger pump along with a hydraulic reservoir (26).

5. According to claim 2: the system uses a crankshaft (14), a connecting rod (15) and three plungers (17) in order to convert the rotary motion into linear one.

6. Rescue system from highly-elevated buildings using automatic control, the landing velocity of the user is analyzed and controlled via four specific systems. This system consists of three valves (23-24-25) for analyzing purposes, flow and hydraulic pressure control and a Variable Centrifugal governor with ability to change the speed of reaction (33) to analyses the landing velocity.

7. According to claim 6: the adjustment of user's landing velocity is implemented using the internal mechanism of the pressure compensated flow control valve (25).

8. According to claim 6: system has a two-groove spool (39) and a freewheeling spool (41).

9. According to claim 6: concurrent of landing the first user via two-groove wire spool (39), the empty section of two-groove spool (39) is filled and through collecting steel wire from freewheeling spool (41), the system is prepared for next user's landing.

10. According to claim 1: the system is equipped with a manual gearbox (34) for swiping up the person.

11. According to claim 1: the system is designed in a way that if the valves malfunction or the landing velocity exceeds its allowable speed, a flow-controlling variable centrifugal governor (33) will override the controlling.

12. According to claim 7, 11: in case of an increase in landing velocity because of excess weight or malfunction of valves (23-24-25), the variable centrifugal governor will put a restriction on the flow rate and therefore decrease the landing velocity.

13. According to claim 1: The system is a standard open loop system with a hydraulic reservoir (26).

14. According to claim 13: the crankshaft (14) has three positions with 120 degrees difference. Considering the fact that in each of the three positions the suction, compression and pressurized discharge actions occur simultaneously, therefore with flow control in each moment the crankshaft speed will decrease in all three positions.

15. According to claim 12: the landing velocity of the user is restricted using the hydraulic flow control via three flow control valves (23-24-25) and a Variable Centrifugal governor with ability to change the speed of reaction (33) which are located in series configuration in the circuit.

16. According to claim 6: in order to avoid Variable Centrifugal governor with ability to change the speed of reaction (33) and three flow control valves (23-24-25) conflict, these actuators are in series in the hydraulic circuit, which means after passing the flow through variable governor's flow control spool (29), it will go through the flow control valves (23-24-25).

17. According to claim 1: while diving and since it will cause a shock to the user's body, the anti-shock hook will neutralize the pressure of the diving shock.

18. According to claim 1: this device will be installed on the building wall or in the utility room. Also, it can be carried in a portable manner by the user to land.

19. According to claim 6: in case of any ruptures in the hydraulic piping or undesirable acceleration of the user, the brake valve (24) will stop the user.

20. According to claim 6: the pressure reducing valve (23) will prevent system failure while landing through controlling the fluctuations and pressure shocks caused by the initial diving of the user.

21. According to claims 6, 7, 19 and 22: if any of these three systems of pressure, flow and shock controls cannot control the landing velocity and any unrestricted acceleration, a Variable Centrifugal governor with ability to change the speed of reaction (33) which is capable of reaction velocity change will excite the flow control spool (29) and make the flow passage thinner to restrict the landing velocity in the allowable margin.
